(19) United States
(12) Patent Application Publication
(10) Pub. No.: US 2004/0218309 A1
(43) Pub. Date: Nov. 4, 2004

(54) Magnetic read head sensors having geometrical magnetoresistance and disc drives including the sensors

(75) Inventor: Michael Allen Seigler, Pittsburgh, PA (US)

Correspondence Address: Robert P. Lenart, Pietragallo, Bosick & Gordon, One Oxford Centre, 38th Floor, 301 Grant Street, Pittsburgh, PA, 15219, US

(73) Assignee: Seagate Technology LLC, Scotts Valley, CA

(21) Appl. No.: 10/425,148

(22) Filed: Apr. 29, 2003

(51) Int. Cl. G11B 5/39

(52) U.S. Cl. 360/313; 428/692; 438/3; 360/112

(57) ABSTRACT

A magnetic read head comprises a magnetic sensor mounted on a back surface of a slider, wherein the magnetic sensor includes a nonmagnetic member, a conductive shunt positioned adjacent to the nonmagnetic member, a first conductor electrically connected to the nonmagnetic member, and a second conductor electrically connected to the nonmagnetic member. Magnetic sensors comprising a nonmagnetic member including a material selected from the group consisting of: Bi, Sb and As, and alloys of Bi, Sb and As; a shunt conductor positioned adjacent to the nonmagnetic member; a first conductor electrically connected to the nonmagnetic member; and a second conductor electrically connected to the nonmagnetic member are also provided. Disc drives that include the read heads and sensors are also included.

### FIELD OF THE INVENTION

This invention relates to magnetic sensors having magnetoresistive read members that can be used in magnetic recording heads, as well as disc drives that include the sensors.

### BACKGROUND OF THE INVENTION

As magnetic data storage areal densities increase, read heads in disc drives need to become physically smaller in both the track-width and bit length directions. Therefore magnetic sensors used in the read heads need to be more sensitive to flux (φ_{media}) from the recording media. As the sensors become smaller, the demagnetization field in the free layer of a standard magnetic sensor, such as a spin-valve (SV) read head or a tunneling magnetoresistance (TMR) read head, becomes larger. Therefore, there is a reduction in the sensitivity of the read head to flux from the media that is ultimately limited by the superparamagnetic limit. This leads to a decreased signal-to-noise ratio. Attempting to increase magnetic stabilization normally will also lead to a decreased sensitivity to flux from the media.

In addition, as the areal densities increase and the access times decrease (by increased media rotation speed), the data rate is naturally increasing. In addition to this natural increase in data rate, there is a desire for higher data rates. Standard magnetic sensors such as SV and TMR read heads may be limited in response time by the gyromagnetic frequency of the free layer. This frequency is on the order of a few GHz for the free layers of the devices (SV and TMR) that are being considered today.

A possible solution to the above problems is to use a magnetic sensor including a nonmagnetic magnetoresistive element. A nonmagnetic magnetoresistive element is defined here as an element that is sensitive to magnetic fields, but does not contain a magnetic free layer as found in SV and TMR devices. Without a magnetic free layer there are no demagnetization fields that reduce sensitivity, there is no magnetic noise due to magnetic fluctuations in the free layer, there is no need for magnetically stabilizing the free layer, and the response time is not limited by the gyromagnetic frequency of the free layer.

A magnetic sensor including a high electron mobility (μₑ) semiconductor and a high conductivity (μₑ) metal shunt has been previously proposed, and the effect was named Extraordinary Magneto-Resistance (EMR). However, this type of sensor has not been accepted for use in magnetic read heads.

There is a need for a magnetic sensor that overcomes the limitations of spin-valve or tunneling magnetoresistance sensors, and which is suitable for use in magnetic read heads that can be used in disc drives.

### SUMMARY OF THE INVENTION

A magnetic read head comprises a magnetic sensor mounted on a back surface of a slider, wherein the magnetic sensor includes a nonmagnetic member, a conductive shunt positioned adjacent to the nonmagnetic member, a first conductor electrically connected to the nonmagnetic member, and a second conductor electrically connected to the nonmagnetic member.

The nonmagnetic member can include a first surface lying generally parallel to an air bearing surface of the slider, and a second surface lying in a plane generally perpendicular to the air bearing surface, wherein the first conductor is electrically connected to the second surface of the nonmagnetic member and the second conductor is electrically connected to the second surface of the nonmagnetic member.

A third conductor can be electrically connected to the second surface of the nonmagnetic member, and a fourth conductor can be electrically connected to the second surface of the nonmagnetic member, where the first and second conductors are positioned between the third and fourth conductors.

In an alternative structure, the nonmagnetic member can include a first surface lying generally parallel to an air bearing surface of the slider, a second surface lying in a first plane generally perpendicular to the air bearing surface, and a third surface lying in a second plane generally perpendicular to the air bearing surface; and wherein the first conductor is electrically connected to the second surface of the nonmagnetic member and the second conductor is electrically connected to the third surface of the nonmagnetic member.

Means can be provided for magnetically biasing the nonmagnetic member, and first and second shields can be positioned on opposite sides of the nonmagnetic member.

The nonmagnetic member can be comprised of: Bi, Sb, As, alloys of Bi, Sb and As; or a semiconductor, including InSb, InAs and quantum wells made out of InSb or InAs.

In another aspect, the invention encompasses a magnetic sensor comprising a nonmagnetic member including a material selected from the group consisting of: Bi, Sb and As, and alloys of Bi, Sb and As; a shunt conductor positioned adjacent to the nonmagnetic member; a first conductor electrically connected to the nonmagnetic member; and a second conductor electrically connected to the nonmagnetic member.

The invention further encompasses a Hall Effect sensor comprising a nonmagnetic member comprised of a material selected from the group consisting of: Bi, Sb and As, and alloys of Bi, Sb and As; a first conductor connected to a first side of the nonmagnetic member; and a second conductor connected to a second side of the nonmagnetic member. The distance between the first and second conductors can be smaller than a height of the nonmagnetic member.

Disc drives that include the read heads and sensors are also included.

### BRIEF DESCRIPTION OF THE DRAWINGS

FIG. 1 is a pictorial representation of a magnetic disc drive that can include magnetic heads constructed in accordance with this invention.

FIG. 2 is an end view of a magnetic recording head including a nonmagnetic sensor constructed in accordance with the invention.

FIG. 3 is a cross-sectional view of the magnetic recording head of FIG. 2.

FIG. 4 is an end view of a magnetic recording head including a nonmagnetic sensor constructed in accordance with the invention.

FIG. 5 is a cross-sectional view of the magnetic recording head of FIG. 4.

FIG. 6 is an end view of a magnetic recording head including a nonmagnetic sensor constructed in accordance with the invention.

FIG. 7 is a cross-sectional view of the magnetic recording head of FIG. 6.

FIG. 8 is an end view of a magnetic recording head including a nonmagnetic sensor constructed in accordance with the invention.

FIG. 9 is a cross-sectional view of the magnetic recording head of FIG. 8.

FIG. 10 is an end view of a magnetic recording head including a nonmagnetic sensor constructed in accordance with the invention.

FIG. 11 is a cross-sectional view of the magnetic recording head of FIG. 10.

FIG. 12 is an end view of a magnetic recording head including a nonmagnetic sensor constructed in accordance with the invention.

FIG. 13 is a cross-sectional view of the magnetic recording head of FIG. 12.

FIG. 14 is an end view of a magnetic recording head including a nonmagnetic sensor constructed in accordance with the invention.

FIG. 15 is a cross-sectional view of the magnetic recording head of FIG. 14.

FIG. 16 is an end view of a magnetic recording head including a nonmagnetic sensor constructed in accordance with the invention.

FIG. 17 is a cross-sectional view of the magnetic recording head of FIG. 16.

FIG. 18 is an end view of a magnetic recording head including a nonmagnetic sensor constructed in accordance with the invention.

FIG. 19 is a cross-sectional view of the magnetic recording head of FIG. 18.

FIG. 20 is an isometric view of a slider having a magnetic sensor constructed in accordance with this invention.

### DETAILED DESCRIPTION OF THE INVENTION

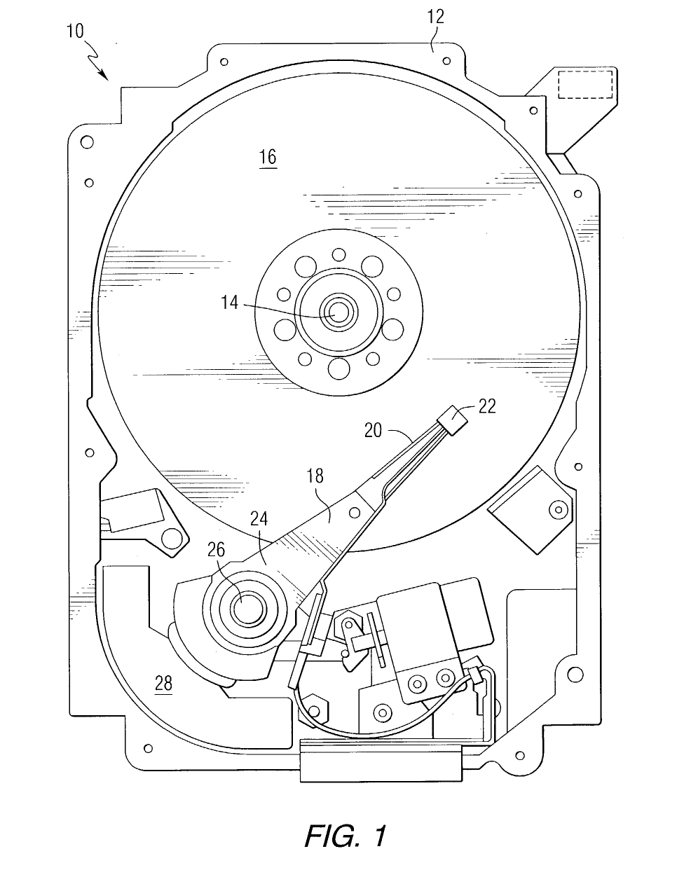

Referring to the drawings, FIG. 1 is a pictorial representation of a disc drive 10 that can utilize magnetic recording heads having magnetic sensors constructed in accordance with this invention. The disc drive includes a housing 12 (with the upper portion removed and the lower portion visible in this view) sized and configured to contain the various components of the disc drive. The disc drive includes a spindle motor 14 for rotating at least one data storage medium 16 within the housing, in this case a magnetic disc. At least one arm 18 is contained within the housing 12, with each arm 18 having a first end 20 with a recording and/or reading head or slider 22, and a second end 24 pivotally mounted on a shaft by a bearing 26. An actuator motor 28 is located at the arm's second end 24, for pivoting the arm 18 to position the head 22 over a desired sector of the disc 16. The actuator motor 28 is regulated by a controller that is not shown in this view and is well known in the art.

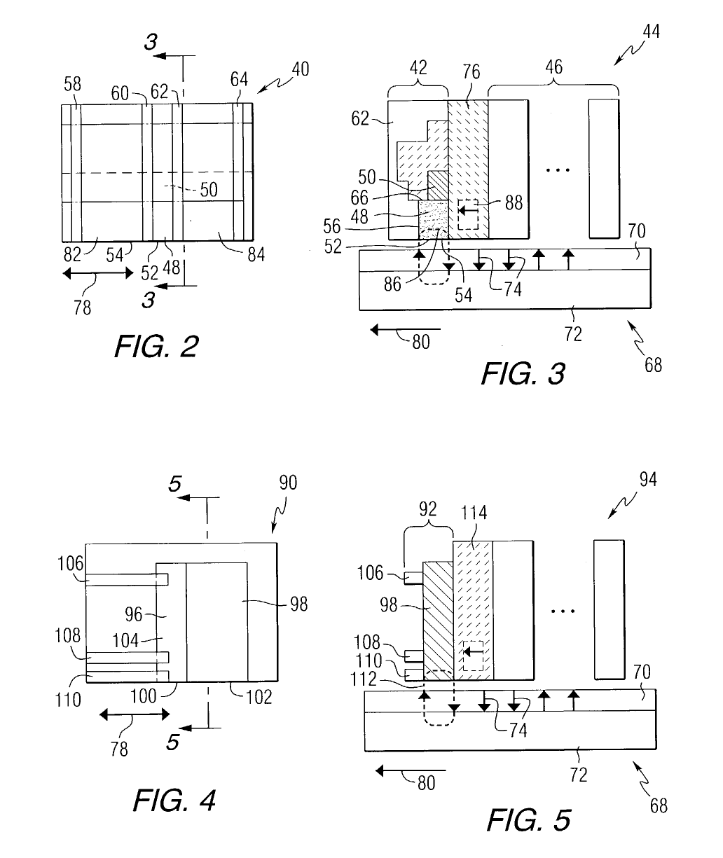

FIG. 2 is an end view of a magnetic recording head 40 including a non-magnetic sensor 42 constructed in accordance with the invention, and FIG. 3 is a cross-sectional view of the magnetic recording head of FIG. 2 taken along line 3-3. The read head includes a four-point contact, current-in-the-plane (CIP) extraordinary magnetoresistance (EMR) sensor 42 that can be mounted on the back of a slider 44. The magnetic recording head 40 can further include other structures such as a write head, generally designated as item 46. The sensor includes a high mobility, nonmagnetic member 48 having a generally rectangular cross-section and being positioned adjacent to a high conductivity shunt 50. The high mobility member 48 includes a first surface 52 positioned adjacent to, and generally parallel to, an air bearing surface (ABS) 54 of the recording head 40. The high mobility member 48 further includes a second surface 56 that lies in a plane generally perpendicular to the ABS. Four conductors 58, 60, 62 and 64 each include a portion adjacent to, and in electrical contact with, the second surface of the high mobility member and make electrical contact with the high mobility member. The shunt member is positioned adjacent to, and in electrical contact with, a third surface 66 of the high mobility member. Conductors 58 and 64 can be connected to a voltage or current source to supply a sense current (also called a bias current) to the high mobility member. Conductors 60 and 62 are positioned between conductors 58 and 64, and serve as voltage sensing contacts. In operation, the slider will be positioned adjacent to a magnetic recording medium 68, for storing data. The example of FIG. 3 shows a perpendicular magnetic recording medium 68, having a magnetically hard layer 70 and a magnetically soft underlayer 72. Arrows 74 illustrate the magnetization of portions of layer 70. When the high mobility nonmagnetic member is subjected to a magnetic field 86, it experiences a change in resistance resulting in a change in voltage between conductors 60 and 62. A layer of insulation 76 separates the current-in-the-plane (CIP) extraordinary magnetoresistance (EMR) sensor from the remainder of the slider 40. Arrow 78 indicates the cross track direction and arrow 80 indicates the down track direction. The material outside of the two innermost electrodes can be the same high mobility material that is between the inner electrodes. Alternatively, that material could be a high conductivity material such as Cu, Au, Al or Ag. Shields may be incorporated into the structure of FIGS. 3 and 4. For example the material 82 between conductors 58 and 60, and the material 84 between conductors 62 and 64 can be a magnetic shielding material such as NiFe, CoFe or CoNiFe.

The head designs shown in FIGS. 2 and 3 would be most sensitive to magnetic fields 86 that are parallel to the ABS in the down track direction. This has been shown to be desirable for perpendicular recording, due to the voltage response not containing a DC component, and the response more closely resembling the voltage output that is seen in longitudinal recording. The magnetoresistance MR can be expressed as: MR=g(μₑH)², where g is a geometrical factor, μₑ is the electron mobility, and H is the applied magnetic field. This response function will not result in the desired linear output for approximately ±200-500 Oe fields from the magnetic recording media. For this reason a bias field may need to be applied in order for the sensor to be operated in a linear region. Magnet 88 can be used to provide the bias field. Alternatively, the inner voltage conductors 60 and 62 may be offset with respect to the current conductors 58 and 64. If the sensor only has two conductors instead of four, the g factor may be limited to values less than one and the option of biasing the sensor by offsetting the conductors is lost.

FIG. 4 is an end view of an alternative magnetic recording head 90 constructed in accordance with the invention. FIG. 5 is a cross-sectional view of the magnetic recording head of FIG. 4 taken along line 5-5. The magnetic recording head includes a three-point contact, current-in-the-plane (CIP) extraordinary magneto-resistance (EMR) sensor 92 mounted on the back of a slider 94. The sensor includes a generally rectangular high mobility member 96 having a generally rectangular cross-section and positioned adjacent to a high conductivity shunt 98. One surface 100 of the high mobility member is positioned adjacent to an air bearing surface (ABS) 102 of the slider. A second surface 104 of the high mobility member lies in a plane generally perpendicular to the ABS. Three conductors 106, 108 and 110 each include a portion, which extends along the second surface of the high mobility member and is in electrical contact with the high mobility member. Conductors 106 and 110 can be connected to a current source to supply current to the high mobility member. Conductors 108 and 110 serve as voltage sensing contacts. In operation, the slider will be positioned adjacent to a magnetic recording medium 68, for storing data. The magnetic recording medium 68 includes a magnetically hard layer 70 and a magnetically soft underlayer 72. Arrows 74 illustrate the magnetization of portions of layer 70. When the high mobility member is subjected to a magnetic field 112, it experiences a change in resistance resulting in a change in voltage between conductors 108 and 110. A layer of insulation 114 separates the CIP EMR sensor from the remainder of the slider 94. Arrow 78 indicates the cross track direction and arrow 80 indicates the down track direction.

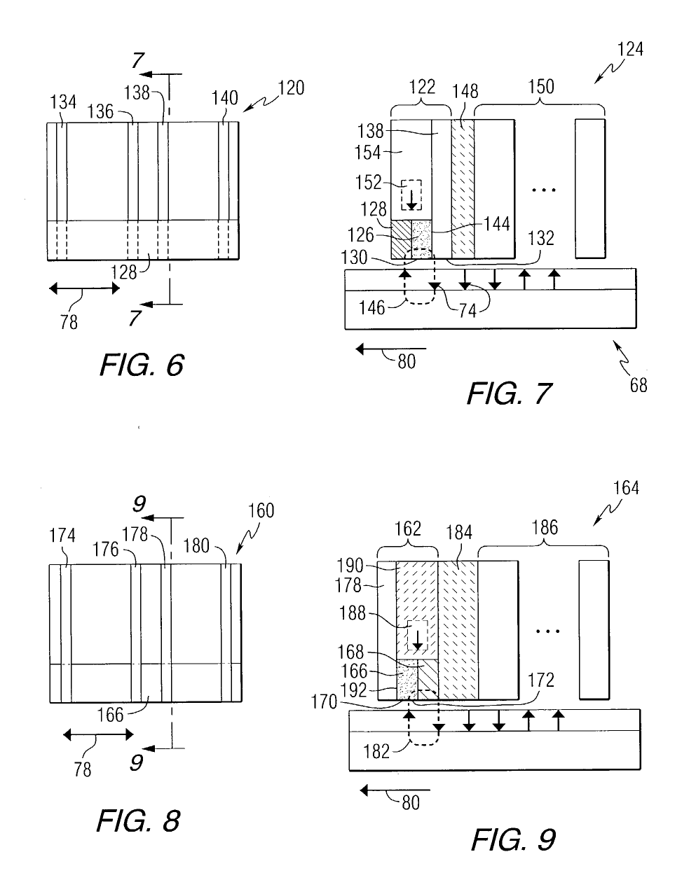

FIG. 6 is an end view of an alternative magnetic recording head 120 constructed in accordance with the invention, and FIG. 7 is a cross-sectional view of the magnetic recording head of FIG. 2 taken along line 7-7. The magnetic recording head 120 includes a four-point contact, transversely oriented current-in-the-plane (CIP) extraordinary magnetoresistance (EMR) sensor 122 mounted on the back of a slider 124. The sensor includes a generally rectangular high mobility member 126 positioned adjacent to a high conductivity shunt 128. One surface 130 of the high mobility member is positioned adjacent to an air bearing surface (ABS) 132 of the slider. Four conductors 134, 136, 138 and 140 each including a portion which extends along a surface 144 of the high mobility member that lies in a plane generally perpendicular to the ABS, and is in electrical contact with the high mobility member. Conductors 134 and 140 can be connected to a voltage or current source to supply sense (or bias) current to the high mobility member and the shunt member. Conductors 136 and 138 are positioned between conductors 134 and 140, and serve as voltage sensing contacts. In operation, the slider will be positioned adjacent to a magnetic recording medium 68, which includes areas of magnetization 74, representative of stored data. When the high mobility member is subjected to a magnetic field 146, it experiences a change in resistance resulting in a change in voltage between conductors 136 and 138. A layer of insulation 148 separates the CIP EMR sensor from the remainder of the slider 124, which can include other well-known structures such as a write head in the area designated as item 150. Arrow 78 indicates the cross track direction and arrow 80 indicates the down track direction. A magnet 152 can be embedded in a layer of insulating material 154 to provide a magnetic bias field for the high mobility member.

FIG. 8 is an end view of an alternative magnetic recording head 160 constructed in accordance with the invention, and FIG. 9 is a cross-sectional view of the magnetic recording head of FIG. 2 taken along line 9-9. The recording head of FIGS. 8 and 9 is similar to that of FIGS. 6 and 7 except that the high mobility member and the shunt member are stacked in a different direction. The magnetic recording head 160 includes a four-point contact, transversely oriented current-in-the-plane (CIP) extraordinary magnetoresistance (EMR) sensor 162 mounted on the back of a slider 164. The sensor includes a generally rectangular high mobility member 166 positioned adjacent to a high conductivity shunt 168. One surface 170 of the high mobility member is positioned adjacent to an air bearing surface (ABS) 172 of the slider. Four conductors 174, 176, 178 and 180 each include a portion that extends along a second surface 192 of the high mobility member and is in electrical contact with the high mobility member. Surface 192 lies in a plane generally perpendicular to the ABS. Conductors 174 and 180 can be connected to a voltage or current source to supply sense (or bias) current to the high mobility member and the shunt member. Conductors 176 and 178 are positioned between conductors 174 and 180, and serve as voltage sensing contacts. In operation, the slider will be positioned adjacent to a magnetic recording medium 68, which includes areas of magnetization 74, representative of stored data. When the high mobility member is subjected to a magnetic field 182, it experiences a change in resistance resulting in a change in voltage between conductors 176 and 178. A layer of insulation 184 separates the CIP EMR sensor from the remainder of the slider 164, which can include other well-known structures such as a write head in the area designated as item 186. Arrow 78 indicates the cross track direction and arrow 80 indicates the down track direction. A magnet 188 can be embedded in a layer of insulating material 190 to provide a magnetic bias field for the high mobility member.

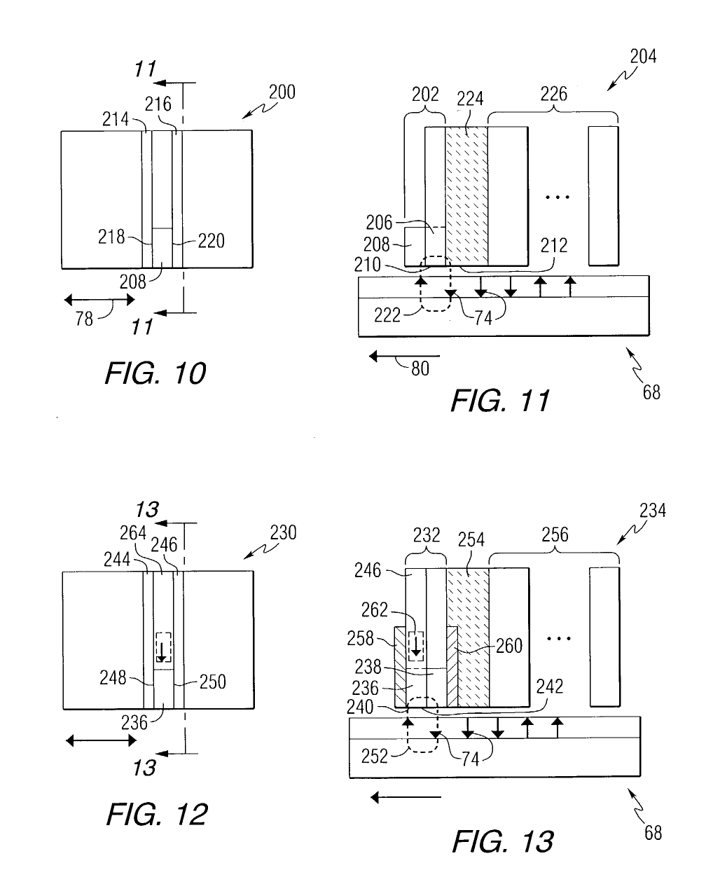

FIG. 10 is an end view of an alternative magnetic recording head 200 constructed in accordance with the invention, and FIG. 11 is a cross-sectional view of the magnetic recording head of FIG. 10 taken along line 11-11. The magnetic recording head includes a two-point contact, current-in-the-plane (CIP) extraordinary magnetoresistance (EMR) sensor 202 mounted on the back of a slider 204. The sensor includes a generally rectangular high mobility member 206 positioned adjacent to a high conductivity shunt member 208. One surface 210 of the high mobility member is positioned adjacent to an air bearing surface (ABS) 212 of the slider. Two conductors 214 and 216 extend along surfaces 218 and 220 on opposite sides of the high mobility member and are in electrical contact with the high mobility member. The conductors 214 and 216 can be connected to a voltage or current source to supply current to the high mobility member, and also serve as voltage sensing contacts. In operation, the slider will be positioned adjacent to a magnetic recording medium 68, which includes areas of magnetization 74, representative of stored data. When the high mobility member is subjected to a magnetic field 222, it experiences a change in resistance resulting in a change in voltage between conductors 214 and 216. A layer of insulation 224 separates the CIP EMR sensor from the remainder of the slider 204, which can include other well-known structures such as a write head in the area designated as item 226. Arrow 78 indicates the cross track direction and arrow 80 indicates the down track direction. This sensor will be most sensitive to the vertical fields in the high mobility layer.

FIG. 12 is an end view of an alternative magnetic recording head 230 constructed in accordance with the invention, and FIG. 13 is a cross-sectional view of the magnetic recording head of FIG. 12 taken along line 13-13. The recording head of FIGS. 12 and 13 is similar to that of FIGS. 10 and 11 except that the high mobility member and the shunt member are stacked in a different direction and means are included for shielding the sensor in the down track direction and for magnetically biasing the sensor. The magnetic recording head includes a two-point contact, current-in-the-plane (CIP) extraordinary magnetoresistance (EMR) sensor 232 mounted on the back of a slider 234. The sensor includes a generally rectangular high mobility member 236 positioned adjacent to a high conductivity shunt member 238. One surface 240 of the high mobility member is positioned adjacent to an air bearing surface (ABS) 242 of the slider. Two conductors 244 and 246 extend along surfaces 248 and 250 on opposite sides of the high mobility member 236 and are in electrical contact with the high mobility member. The conductors 244 and 246 can be connected to a voltage or current source to supply current to the high mobility member, and also serve as voltage sensing contacts. In operation, the slider will be positioned adjacent to a magnetic recording medium 68, which includes areas of magnetization 74, representative of stored data. When the high mobility member is subjected to a magnetic field 252, it experiences a change in resistance resulting in a change in voltage between conductors 244 and 246. A layer of insulation 254 separates the CIP EMR sensor from the remainder of the slider 234, which can include other well-known structures such as a write head in the area designated as item 256. Arrow 78 indicates the cross track direction and arrow 80 indicates the down track direction. Shields 258 and 260 are mounted on opposites sides of the sensor in the down track direction. Shielding can be provided in the cross track direction by making the conductors out of a shield material. A magnet 262 can be positioned in a layer of insulating material 264 to provide a magnetic bias for the high mobility member.

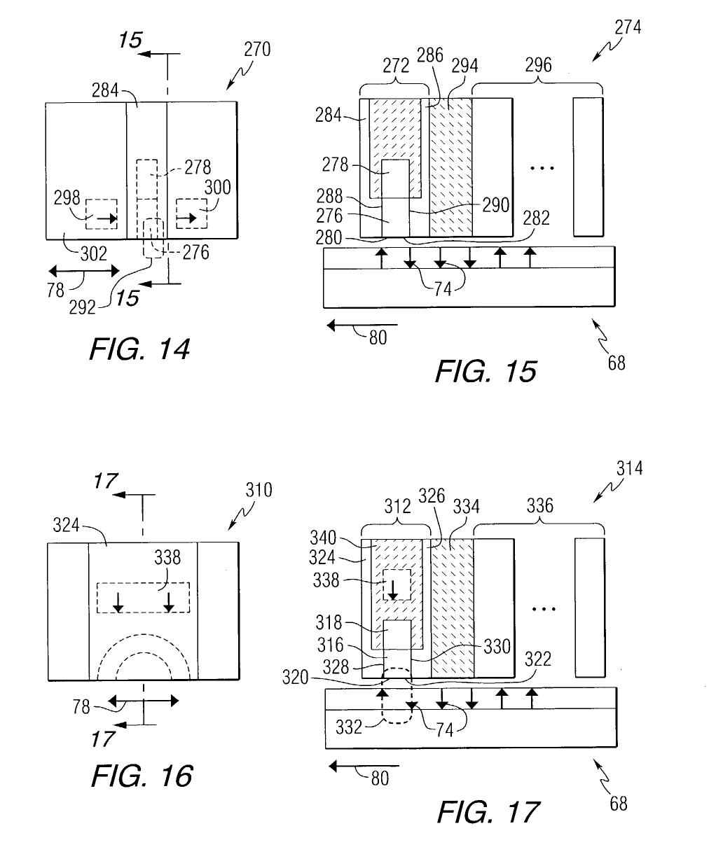

FIG. 14 is an end view of an alternative magnetic recording head 270 constructed in accordance with the invention, and FIG. 15 is a cross-sectional view of the magnetic recording head of FIG. 14 taken along line 15-15. The magnetic recording head includes a two-point contact, current-perpendicular-to-the-plane (CPP) extraordinary magnetoresistance (EMR) sensor 272 mounted on the back of a slider 274. The sensor includes a generally rectangular high mobility member 276 positioned adjacent to a high conductivity shunt member 278. One surface 280 of the high mobility member is positioned adjacent to an air bearing surface (ABS) 282 of the slider. Two conductors 284 and 286 extend along surfaces 288 and 290 on opposite sides of the high mobility member and are in electrical contact with the high mobility member. The conductors 284 and 286 can be connected to a voltage or current source to supply current to the high mobility member, and also serve as voltage sensing contacts. In operation, the slider will be positioned adjacent to a magnetic recording medium 68, which includes areas of magnetization 74, representative of stored data. When the high mobility member is subjected to a cross track magnetic field 292, it experiences a change in resistance resulting in a change in voltage between conductors 284 and 286. A layer of insulation 294 separates the CPP EMR sensor from the remainder of the slider 274, which can include other well-known structures such as a write head in the area designated as item 296. Arrow 78 indicates the cross track direction and arrow 80 indicates the down track direction. Magnets 298 and 300 can be positioned in a layer of insulating material 302 to provide a magnetic bias for the high mobility member.

FIG. 16 is an end view of an alternative magnetic recording head 310 constructed in accordance with the invention, and FIG. 17 is a cross-sectional view of the magnetic recording head of FIG. 16 taken along line 17-17. The magnetic recording head includes a two-point contact, current-perpendicular-to-the-plane (CPP) extraordinary magnetoresistance (EMR) sensor 312 mounted on the back of a slider 314. The sensor includes a generally rectangular high mobility member 316 positioned adjacent to a high conductivity shunt member 318. One surface 320 of the high mobility member is positioned adjacent to an air bearing surface (ABS) 322 of the slider. Two conductors 324 and 326 extend along surfaces 328 and 330 on opposite sides of the high mobility member and are in electrical contact with the high mobility member. The conductors 324 and 326 can be connected to a voltage or current source to supply current to the high mobility member, and also serve as voltage sensing contacts. In operation, the slider will be positioned adjacent to a magnetic recording medium 68, which includes areas of magnetization 74, representative of stored data. When the high mobility member is subjected to a magnetic field 332, it experiences a change in resistance resulting in a change in voltage between conductors 324 and 326. A layer of insulation 334 separates the CPP EMR sensor from the remainder of the slider 314, which can include other well-known structures such as a write head in the area designated as item 336. Arrow 78 indicates the cross track direction and arrow 80 indicates the down track direction. A magnet 338 can be positioned in a layer of insulating material 340 to provide a magnetic bias for the high mobility member.

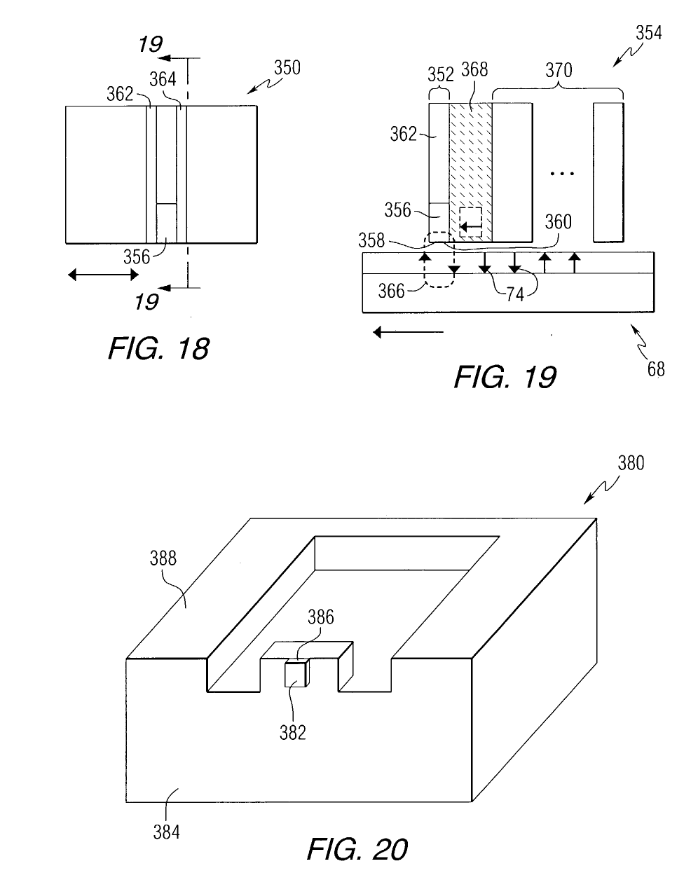

FIG. 18 is an end view of an alternative magnetic recording head 350 constructed in accordance with the invention, and FIG. 19 is a cross-sectional view of the magnetic recording head of FIG. 18 taken along line 19-19. The magnetic recording head includes a two-point shorted Hall Effect sensor 352 mounted on the back of a slider 354. The sensor includes a generally rectangular Hall member 356. One surface 358 of the Hall member is positioned adjacent to an air bearing surface (ABS) 360 of the slider. Two conductors 362 and 364 extend along opposite sides of the Hall member and are in electrical contact with the Hall member. Conductors 362 and 364 can be connected to a voltage or current source to supply current to the Hall member. In operation, the slider will be positioned adjacent to a magnetic recording medium 68, which includes areas of magnetization 74, representative of stored data. When the high mobility member is subjected to a magnetic field 366, it experiences a change in resistance resulting in a change in voltage between conductors 362 and 364. A layer of insulation 368 separates the Hall member sensor from the remainder of the slider 354, which can include other well-known structures such as a write head in the area designated as item 370. Arrow 78 indicates the cross track direction and arrow 80 indicates the down track direction.

FIG. 20 is an isometric view of a slider 380 having a magnetic sensor 382 constructed in accordance with this invention. The sensor is mounted on a back surface 384 of the slider. In this example, the back surface 384 lies in a plane generally perpendicular to the air bearing surface. An edge 386 of the sensor is positioned adjacent to the air bearing surface 388 of the slider. By mounting the sensor on the back surface of the slider, as opposed to the underside of the slider shown in previous designs, this invention avoids many fabrication problems such as fabricating both a read head and write head that have a planar design, co-location of the proper ABS location for both the read head and write head, and getting both the read head and write head near the back of the slider to maintain a <10 nm head-to-media separation.

A method of making an unshielded CIP EMR head shown in FIGS. 2 and 3 can now be described.

1) Start with a substrate such as AlTiC, Si, GaAs, or other suitable material.

2) Deposit buffer layers as necessary. If no epitaxial growth on the substrate is needed, the buffer layer may include an insulator such as Al₂O₃, SiO₂, AlON, SiON, or other suitable material. If epitaxial growth on the substrate is needed in order to achieve the desired properties in the high mobility layer, these layers would be deposited here, such as InSb, InAs, InAlAs, or other suitable material.

3) Deposit the high mobility material over the entire wafer.

4) Pattern the high mobility material using lithographic means such as optical or electron beam-lithography. Etch the high mobility material to define the dimension in the track width direction. The etch process could be a process such as reactive ion etching (RIE), inert ion beam etching (IBE), reactive ion beam etching (RIBE), or other suitable process.

5) Deposit an insulating layer using a process such as ion beam deposition (IBD), electron beam or resistive evaporation, molecular beam epitaxy (MBE), sputtering, chemical vapor deposition, or other suitable process.

6) Use lift-off to remove the insulator from the wafer, leaving the insulator locally planar with the high μₑ material. Processes such as IBE or chemical mechanical polishing (CMP) lift-off assist may be used as necessary.

7) Pattern the high mobility material using lithographic means such as optical or electron beam lithography. Etch a cavity behind the high mobility material defining the dimension in the stripe height direction.

8) Deposit the high conductivity, σ, material into the cavity using a process such as ion beam deposition (IBD), electron beam evaporation, molecular beam epitaxy (MBE), sputtering, or other suitable process. The high conductivity materials can be, for example, Au, Cu, Ag and Al.

9) Cap the high σ layer with an insulation layer such as Al₂O₃, SiO₂, AlON, and SiON, using a deposition process similar to the ones listed above.

10) Use lift-off to remove the high σ material from the wafer, leaving it in the cavity. Processes such as IBE or chemical mechanical polishing (CMP) lift-off assist may be necessary.

11) Define a box using lithographic process over the high mobility material and part of the high σ films.

12) Deposit an insulating layer to help prevent shorting from the leads to the high σ material.

13) Form the top leads using either a lift-off process or a deposition and etch process.

Shields can be added to the CIP EMR head shown in FIGS. 2 and 3 using the following process.

1) If a special buffer layer is not needed, shields and an insulator can be deposited after the insulating buffer layer, and then the high mobility film would be deposited on top of the insulator. If a special semiconductor buffer layer is needed, a ferromagnetic semiconductor such as GaMnN or GaAsMn may be used as a shield material.

2) After forming the top leads, an insulator and top shield can be formed. This would be formed in much the same manner as the shields in a standard CIP spin-valve sensor.

3) Side shields could be formed by replacing the high mobility material between leads 58 and 60, and leads 62 and 64 with a soft magnetic material, such as NiFe, CoFe, CoNiFe or other suitable material. This should be relatively easy to do since the spacing between leads 62 and 64 is the critical dimension that determines the track width and the spacings between leads 58 and 60, and 62 and 64 are not particularly important.

Magnetic biasing can be added to the CIP EMR head shown in FIGS. 2 and 3 using the following process.

1) A permanent magnet or a soft magnetic material exchange coupled to an antiferromagnetic material could be deposited before and/or after the high mobility material. This biasing layer would have a magnetization oriented perpendicular to the plane of the film in order to bias the sensor into a linear region. For designs in FIGS. 6-9 it would be relatively easy to add biasing by mounting a permanent magnet above the sensor (opposite of the sensor from the ABS), with a magnetization oriented perpendicular to the ABS. For the design in FIGS. 14-15 a permanent magnet could be mounted on the sides of the device. In an alternative structure, the shunt layer could be made of a permanent magnet with the magnetization oriented appropriately.

Similar processing as used for FIGS. 2 and 3 could be used for the devices shown in FIGS. 4-19. Only the key differences will be highlighted.

The key difference between FIGS. 2 and 3, and FIGS. 4 and 5 is just the orientation of the high mobility and high σ films with respect to the ABS. This would not have much effect on the processing. If the high σ material was made of soft magnetic material, such as NiFe, CoFe, CoNiFe, this would act as a side shield. If after patterning the high mobility material an insulator/shield material combination was deposited, a side shield would be formed on the other side of the sensor.

The key difference between FIGS. 2 and 3, and FIGS. 6-9 is the orientation of the high mobility and high σ films. In FIGS. 6-9 the films are deposited one on top of the other instead of one behind the other. The high mobility and high a materials are stacked in the down track direction. In general, they can be stacked in either order (either one can be on top) and the leads will contact the high mobility material. If the high σ material includes a shield material, it will act as a down track shield. A two lead, side lead structure could also be used with a high mobility and high σ arrangement as shown in FIGS. 2 and 3. This two lead, side lead structure may make it easier to incorporate side shields.

The devices shown in FIGS. 14-17 are different from those described above in that the current in these devices is traveling perpendicular to the plane of the films. For these devices, the leads can be made of a shield material, which would provide down track shielding. In FIGS. 16 and 17, the high σ material could be a shield material and it would provide cross track shielding.

FIGS. 18 and 19 show a simplified CIP, shorted Hall Effect sensor. The sensor includes a high mobility material between two conductors. This design could also be made using a CPP structure. Incorporating shields and biasing would be straightforward for both the CIP and CPP designs. The field from the media would cause the electrons to travel in an arc within the high mobility material, and therefore see a higher resistance between the conductors. The dimensions would need to be selected such that a reverse voltage (Hall voltage) is not set up that counter balances the Lorentz force from the applied field. This would be the case for a conductor-to-conductor spacing smaller than the stripe height of the sensor. That is, the distance between the first and second conductors is small compared to the height of the nonmagnetic member such that an applied magnetic field produces a change in electrical resistance between the first and second conductors.

The sensors of this invention can use semimetals and some of the designs can use either a semimetal or a narrow bandgap semiconductor. In a semimetal, the valance and conduction band overlap slightly, such as Bi, Sb and As. These materials also have very high mobilities. If the mobility is calculated for Bi using bulk parameters, it is larger than that measured for the best semiconductors. Using μ=1/(pen), where p is the resistivity, e is the electron charge, and n is the electron carrier density, one can calculate μₑ. Using p=116 μOhm-cm and n=2.88e¹⁷ cm³ for Bi, one calculates μ (Bi)=18.7 m²/V/sec. InSb, on the other hand, has a maximum μₑ=7 m²/V/sec. This high mobility has not been previously realized for Bi, possibly because the previous measurements are macroscopic measurements. For the device sizes of interest in the present invention (<100 nm), the device size can be made smaller than the grain size. This may make the effective mobility for the electrons within the device much higher than that measured in a macroscopic test structure where the electrons encounter many grain boundaries. Annealing Bi and/or choosing a good seedlayer material may easily result in grains larger than 100 nm. Due to the low melting point of Bi, anneal temperatures do not need to be large in order to increase the grain size significantly (<270° C.). In addition, alloying Bi with other materials to expand or contract the lattice may result in an increased mobility, similar to adding Ge to Si to increase the mobility of the Si. By having a high mobility metal that can be sputtered, instead of an MBE grown quantum well, the structures of this invention can be more easily fabricated than previously proposed nonmagnetic sensors.

The sensors of this invention can be made using materials that are compatible with the current magnetic recording head processing and can be fabricated on the back of a slider instead of on the bottom of the slider. The various examples also show means for incorporating magnetic shielding and/or magnetic biasing if needed.

In the above description, the word “adjacent” has been used to describe a relationship of the position of various elements with respect to each other. It should be understood that adjacent means both in contact with, or near to. For example, a thin layer of material, such as a buffer layer can be positioned between adjacent layers, but the layers would still fall within the meaning of the word adjacent.

While the present invention has been described in terms of several examples, it will be apparent to those skilled in the art that various changes can be made to the disclosed examples without departing from the scope of the invention as defined by the following claims.

What is claimed is:

1. A magnetic read head comprising:
a magnetic sensor mounted on a back surface of a slider, wherein the magnetic sensor includes a nonmagnetic member, a conductive shunt positioned adjacent to the nonmagnetic member, a first conductor electrically connected to the nonmagnetic member, and a second conductor electrically connected to the nonmagnetic member.

2. The magnetic read head of claim 1, wherein the nonmagnetic member includes:
a first surface lying generally parallel to an air bearing surface of the slider; and
a second surface lying in a plane generally perpendicular to the air bearing surface; and
wherein the first conductor is electrically connected to the second surface of the nonmagnetic member and the second conductor is electrically connected to the second surface of the nonmagnetic member.

3. The magnetic read head of claim 2, further comprising:
a third conductor electrically connected to the second surface of the nonmagnetic member.

4. The magnetic read head of claim 3, further comprising:
a fourth conductor electrically connected to the second surface of the nonmagnetic member, where the first and second conductors are positioned between the third and fourth conductors.

5. The magnetic read head of claim 1, wherein the nonmagnetic member includes a first surface lying generally parallel to an air bearing surface of the slider, a second surface lying in a first plane generally perpendicular to the air bearing surface, and a third surface lying in a second plane generally perpendicular to the air bearing surface; and wherein the first conductor is electrically connected to the second surface of the nonmagnetic member and the second conductor is electrically connected to the third surface of the nonmagnetic member.

6. The magnetic read head of claim 1, further comprising:
means for magnetically biasing the nonmagnetic member.

7. The magnetic read head of claim 1, further comprising:
first and second shields positioned on opposite sides of the nonmagnetic member.

8. The magnetic read head of claim 1, wherein the nonmagnetic member is comprised of a material selected from the group consisting of: Bi, Sb and As, and alloys of Bi, Sb and As.

9. The magnetic read head of claim 1, wherein the nonmagnetic member is comprised of a semiconductor.

10. The magnetic read head of claim 9, wherein the semiconductor is comprised of a material selected from the group consisting of: InSb, InAs and quantum wells made out of InSb or InAs.

11. The magnetic read head of claim 1, wherein the conductive shunt is comprised of a material selected from the group consisting of: Cu, Au, Al and Ag.

12. The magnetic read head of claim 1, wherein the conductive shunt is comprised of a material selected from the group consisting of: NiFe, CoFe and CoNiFe.

13. The magnetic read head of claim 1, further comprising:
a first conductive shield connected to a first end of the nonmagnetic member;
a second conductive shield connected to a second end of the nonmagnetic member;
a third conductor connected to the first conductive shield; and
a fourth conductor connected to the second conductive shield.

14. The magnetic read head of claim 13, wherein each of the first and second conductive shields is comprised of a material selected from the group consisting of: NiFe, CoFe and CoNiFe.

15. A disc drive comprising:
means for rotating a storage medium;
means for positioning a recording head adjacent to a surface of the storage medium; and
a magnetic sensor mounted on a back surface of a slider; and
the magnetic sensor including a nonmagnetic member, a conductive shunt positioned adjacent to the nonmagnetic member, a first conductor electrically connected to the nonmagnetic member, and a second conductor electrically connected to the nonmagnetic member.

16. The disc drive of claim 15, wherein the nonmagnetic member includes a first surface lying generally parallel to an air bearing surface of the slider and a second surface lying in a plane generally perpendicular to the air bearing surface; and wherein the first conductor is electrically connected to the second surface of the nonmagnetic member and the second conductor is electrically connected to the second surface of the nonmagnetic member.

17. The disc drive of claim 16, further comprising:
a third conductor electrically connected to the second surface of the nonmagnetic member.

18. The disc drive of claim 17, further comprising:
a fourth conductor electrically connected to the second surface of the nonmagnetic member, where the first and second conductors are positioned between the third and fourth conductors.

19. The disc drive of claim 15, wherein the nonmagnetic member includes a first surface lying generally parallel to an air bearing surface of the slider, a second surface lying in a first plane generally perpendicular to the air bearing surface, and a third surface lying in a second plane generally perpendicular to the air bearing surface; and wherein the first conductor is electrically connected to the second surface of the nonmagnetic member and the second conductor is electrically connected to the third surface of the nonmagnetic member.

20. The disc drive of claim 15, further comprising:
means for magnetically biasing the nonmagnetic member.

21. The disc drive of claim 15, further comprising:
first and second shields positioned on opposite sides of the nonmagnetic member.

22. The disc drive of claim 15, wherein the nonmagnetic member is comprised of a material selected from the group consisting of: Bi, Sb and As, and alloys of Bi, Sb and As.

23. The disc drive of claim 15, wherein the nonmagnetic member is comprised of a semiconductor.

24. The disc drive of claim 23, wherein the semiconductor is comprised of a material selected from the group consisting of: InSb, InAs and quantum wells made out of InSb or InAs.

25. The disc drive of claim 15, wherein the conductive shunt is comprised of a material selected from the group consisting of: Cu, Au, Al and Ag.

26. The disc drive of claim 15, wherein the conductive shunt is comprised of a material selected from the group consisting of: NiFe, CoFe and CoNiFe.

27. The disc drive of claim 15, further comprising:
a first conductive shield connected to a first end of the nonmagnetic member;
a second conductive shield connected to a second end of the nonmagnetic member;
a third conductor connected to the first conductive shield; and
a fourth conductor connected to the second conductive shield.

28. The disc drive of claim 27, wherein each of the first and second conductive shields is comprised of a material selected from the group consisting of:
NiFe, CoFe and CoNiFe.

29. A magnetic sensor comprising:
a nonmagnetic member including a material selected from the group consisting of: Bi, Sb and As, and alloys of Bi, Sb and As;
a shunt conductor positioned adjacent to the nonmagnetic member;
a first conductor electrically connected to the nonmagnetic member; and
a second conductor electrically connected to the nonmagnetic member.

30. The magnetic sensor of claim 29, further comprising:
means for magnetically biasing the nonmagnetic member.

31. The magnetic sensor of claim 29, further comprising:
a third conductor electrically connected to the nonmagnetic member.

32. The magnetic sensor of claim 31, further comprising:
a fourth conductor electrically connected to the nonmagnetic member, where the first and second conductors are positioned between the third and fourth conductors.

33. The magnetic sensor of claim 29, further comprising:
first and second shields positioned on opposite sides of the nonmagnetic member.

34. The magnetic sensor of claim 33, further comprising:
a third conductor electrically connected to the first shield; and
a fourth conductor electrically connected to the second shield.

35. The magnetic sensor of claim 29, wherein the shunt conductor is comprised of a material selected from the group consisting of: Cu, Au, Al and Ag.

36. The magnetic sensor of claim 29, wherein the shunt conductor is comprised of a material selected from the group consisting of: NiFe, CoFe and CoNiFe.

37. A disc drive comprising:
means for rotating a storage medium;
means for positioning a recording head adjacent to a surface of the storage medium; and
a magnetic sensor with a nonmagnetic member comprised of a material selected from the group consisting of: Bi, Sb and As, and alloys of Bi, Sb and As;
a shunt conductor positioned adjacent to the nonmagnetic member;
a first conductor electrically connected to the nonmagnetic member; and
a second conductor electrically connected to the nonmagnetic member.

38. The disc drive of claim 37, further comprising:
means for magnetically biasing the nonmagnetic member.

39. The disc drive of claim 37, further comprising:
a third conductor electrically connected to the nonmagnetic member.

40. The disc drive of claim 39, further comprising:
a fourth conductor electrically connected to the nonmagnetic member, where the first and second conductors are positioned between the third and fourth conductors.

41. The disc drive of claim 37, further comprising:
first and second shields positioned on opposite sides of the nonmagnetic member.

42. The disc drive of claim 41, further comprising:
a third conductor electrically connected to the first shield; and
a fourth conductor electrically connected to the second shield.

43. The disc drive of claim 37, wherein the shunt conductor is comprised of a material selected from the group consisting of: Cu, Au, Al and Ag.

44. The disc drive of claim 37, wherein the shunt conductor is comprised of a material selected from the group consisting of: NiFe, CoFe and CoNiFe.

45. A Hall Effect sensor comprising:
a nonmagnetic member comprised of a material selected from the group consisting of: Bi, Sb and As, and alloys of Bi, Sb and As;
a first conductor connected to a first side of the nonmagnetic member; and
a second conductor connected to a second side of the nonmagnetic member.

46. The Hall Effect sensor of claim 45, wherein a distance between the first and second conductors is smaller than a height of the nonmagnetic member.

47. The Hall Effect sensor of claim 45, wherein a distance between the first and second conductors is small compared to the height of the nonmagnetic member such that an applied magnetic field produces a change in electrical resistance between the first and second conductors.

48. A disc drive comprising:
means for rotating a storage medium;
means for positioning a recording head adjacent to a surface of the storage medium; and
a Hall Effect sensor mounted on the recording head, the Hall Effect senor including a nonmagnetic member comprised of a material selected from the group consisting of: Bi, Sb and As, and alloys of Bi, Sb and As, a first conductor connected to a first side of the nonmagnetic member, and a second conductor connected to a second side of the nonmagnetic member.

49. The disc drive of claim 48, wherein a distance between the first and second conductors is smaller than a height of the nonmagnetic member.

50. The disc drive of claim 48, wherein a distance between the first and second conductors is small compared to the height of the nonmagnetic member such that an applied magnetic field produces a change in electrical resistance between the first and second conductors.
